(19) United States
(12) Patent Application Publication
(10) Pub. No.: US 2007/0183962 A1
(43) Pub. Date: Aug. 9, 2007

(54) Reduction of the concentration of undesired compounds

(76) Inventors: Samantha J. Brown, Northwich (GB); Stuart Corr, Warrington (GB); Robert E. Low, Nercwys (GB)

Correspondence Address: RYAN KROMHOLZ & MANION, S.C., POST OFFICE BOX 26618, MILWAUKEE, WI, 53226, US

(21) Appl. No.: 10/564,864

(22) PCT Filed: Jul. 19, 2004
(86) PCT No.: PCT/GB04/03115

§ 371 Date: Dec. 22, 2006

(30) Foreign Application Priority Data
Jul. 18, 2003 (GB) 0316760.8

(51) Int. Cl. C01F 11/22

(52) U.S. Cl. 423/490; 423/658.5

(57) ABSTRACT

A process for treating a composition comprising one or more undesired compounds and one or more desired compounds so as to reduce the concentration of the one or more undesired compounds is described. The process comprises the steps of (1) contacting the composition with an extraction solvent comprising a (hydro)fluorocarbon, and (2) separating the solvent from the one or more desired compounds; wherein one or more of the desired compounds is an inorganic material provided that water is not the only desired material. The process is particularly suited to reducing the content of sulfur and/or nitrogen containing compounds in inorganic fluorides.

This invention relates to a process for reducing the concentration of one or more undesired compounds in a composition containing those compounds and one or more desired compounds.

More particularly, the present invention relates to a process for reducing the concentration of undesired compounds such as (but not limited to) sulfur and/or nitrogen containing compounds in inorganic materials such as (but not limited to) alkali metal and alkaline earth metal halides, especially fluorides such as calcium fluoride or potassium fluoride.

Calcium fluoride, CaF₂, is a by-product of many industrial processes. For example, it is a by-product of HF-catalysed alkylation reactions performed in the oil-refining industry. The spent HF catalyst from these reactions is typically neutralised using potassium hydroxide, KOH. This generates potassium fluoride, KF, and water, containing excess KOH. The KOH can then be subjected to any suitable further processing. For example, it is typically recovered from the KF for recycling by a neutralisation process in which a suitable agent such as calcium hydroxide Ca(OH)₂ is added to the KF in KOH solution. This reaction produces calcium fluoride, CaF₂ as a by-product.

CaF₂ obtained in this manner is contaminated and is in the form of a maloderous, oily residue that renders it useless as a feedstock for any of its common uses such as preparation of hydrofluoric acid and in metal-working. The residue contains many compounds that contribute to the malodour. These compounds are thought to be mainly sulfur and/or nitrogen containing compounds. The smell of the residue makes the CaF₂ unpleasant to work with (other than within a totally closed system or a very well ventilated fume-cupboard, which is not always practical) and the waxy/oily consistency of the residue makes the CaF₂ difficult to work with. There is also a quantity of KOH bound in the CaF₂ and this also makes this CaF₂ unusable as a feed material. At present, CaF₂ generated in this way is sent as chemical waste to landfill sites.

It is an object of the present invention to provide a process that can be used remove undesired compounds from inorganic materials. It is a particular object of the invention to provide a process that can be used to render CaF₂ generated in the manner described above useful. However, it will be appreciated that the process described may be used to remove undesired compounds from CaF₂ obtained in other ways and from other inorganic materials.

WO98/24518 describes a process for removing organic solvents from a mass of material. This process comprises contacting the mass of material with a C₁-C₄ fluorinated hydrocarbon solvent so as to charge the fluorinated solvent with the organic solvent and separating the charged solvent from the remainder of the mass of material.

The listing or discussion of a prior-published document in this specification should not necessarily be taken as an acknowledgement that the document is part of the state of the art or is common general knowledge

The present invention provides a new process for reducing the concentration of one or more undesired compounds in a composition containing those compounds and one or more desired compounds.

According to the present invention, there is provided a process for treating a composition comprising one or more undesired compounds and one or more desired compounds so as to reduce the concentration of at least one of the undesired compounds, which process comprises the steps of:
(1) contacting the composition with an extraction solvent comprising a (hydro)fluorocarbon, and
(2) separating the solvent from the one or more desired compounds; wherein one or more of the desired compounds is an inorganic material, provided that water is not the only desired material.

In the process of the invention, the undesired compound(s) are extracted into the extraction solvent in step (1) and are thus removed from the desired compound(s) when the solvent is separated from the desired compound(s) in step (2).

Preferably the desired inorganic material is a halogen containing inorganic material, such as a metal halide, for example an alkali metal or alkaline earth metal halide. More preferably the desired inorganic material is a fluorine containing inorganic material, such as a metal fluoride, for example an alkali metal fluoride such as potassium fluoride or an alkaline earth metal fluoride such as calcium fluoride.

The process of the present invention can be used to remove any undesired compounds that can be extracted from the desired compounds by the extraction solvent under the conditions used.

By the term “undesired compounds” we mean any compound that has an undesirable effect on the properties of desired compound(s). For example, the undesired compounds may effect the smell, chemical properties, physical properties or the morphology of the desired compound(s).

The present invention is particularly suitable for the removal of odoriferous compounds, such as those that cause a momentary or even a lingering malodor.

As used herein, the words “remove”, “removes” and “removed” used with reference to the undesired compounds are intended to indicate a reduction in the amount of the undesired compound and not its complete removal unless explicitly stated.

Odoriferous compounds that may be removed using the process of the present invention include, but are not limited to, sulfur and/or nitrogen containing compounds.

The process can reduce the concentration of inorganic and/or organic sulfur and/or nitrogen containing compounds. It is particularly advantageous to use the process to reduce the concentration of organic sulfur and/or nitrogen containing impurities because these can typically be more difficult to remove using standard techniques known to those skilled in the art.

By the term “organic sulfur containing compounds” we mean compounds s containing at least carbon and sulfur, optionally including other atoms such as hydrogen, nitrogen and oxygen. Organic sulfur containing compounds that may be removed using the process of the present invention include, but are not limited to, those containing up to 10 carbon atoms, preferably 1 to 6 carbon atoms, they may be straight chain, branched or cyclic compounds and may optionally contain other hetero atoms such as oxygen or nitrogen, the number of sulfur atoms in the molecule is not limited and may for example be 1, 2 or 3.

By the term “inorganic sulfur containing compounds” we mean compounds containing at least sulfur, optionally including other atoms such as hydrogen and oxygen.

Examples of sulfur containing compounds that may be removed using the inventive process include, but are not limited to, carbon disulfide, carbonyl sulfide, dimethyldisulfide, ethanethiol, diethyldisulfide, 1,3-dihydro-2H-imidazole-2-thione, 2-(methylthio)-propane, 2-(methylthio)-butane, 1-(methylthio)-butane, methylethyldisulfide, 2-(ethylthio)-butane, sec-butyl isopropylsulfide, 1-(ethylthio)-butane, 1-[(methylethyl)thio]butane and bis[2-(ethylthio)ethyl]ether.

By the term “organic nitrogen containing compounds” we mean compounds containing at least carbon and nitrogen, optionally including other atoms such as hydrogen, sulfur and oxygen. Organic nitrogen containing compounds that may be removed using the process of the present invention include but are not limited to those containing up to 10 carbon atoms, preferably 1 to 6 carbon atoms, they may be straight chain, branched or cyclic compounds and may optionally contain other hetero atoms such as oxygen or sulfur, the number of nitrogen atoms in the molecule is not limited and may for example be 1, 2 or 3.

By the term “inorganic nitrogen containing compounds” we mean compounds containing at least nitrogen, optionally including other atoms such as hydrogen and oxygen.

Examples of nitrogen containing compounds that may be removed using the inventive process include, but are not limited to, ammonia, nitromethane, methylamine, dinethylamine, trimethylamine, LDA (lithium diisopropylamide), hydroxylamine, ureas, ethylamine, diethylamine, triethylamine, 1,3-dihydro-2H-imidazole-2-thione, N,N-dimethyl-ethanethioamide and 2,2-dimethoxy-N-methyl-ethanamine.

The process can typically be used to remove the undesired compounds so that they are present at a level that does not effect the properties of the desired compounds. For example, the process may typically remove at least 50% by weight, more preferably at least 90% by weight and even more preferably at least 98% by weight of the undesired compounds.

Before treatment, each undesired compound is typically present in the compositions at levels of from the limit of detection to about 5% by weight. For example, compounds such as 1,3-dihydro-2H-imidazole-2-thione, N,N-dimethyl ethanethioamide, 2-(methylthio)-propane, dimethyldisulfide, 2-(methylthio)-butane, 1-(methylthio)-butane, methylethyldisulfide, 2-(ethylthio)-butane, sec-butyl isopropylsulfide, 1-(ethylthio)-butane, 1-[(methylethyl)thio] butane, 2,2-dimethoxy-N-methyl ethanamine and bis[2-(ethylthio)ethyl] ether may each be present in an amount of up to 0.1% by weight.

When the process is used to remove sulfur containing compounds, it preferably reduces the concentration of those compounds to levels below the limit of detection by standard equipment, i.e. so that they are virtually entirely removed. By the term “limit of detection” we mean the point at which the sulfur containing compounds cannot be detected by smell and/or by gas chromatography with pulsed flame photometric detection set to “sulfur” mode. For example, the limit of detection by gas chromatography may be at levels of approximately 5 ppb and below. Thus, the process is preferably effective at removing malodor caused by sulfur containing compounds.

Similarly, when the process is used to remove nitrogen containing compounds, it preferably reduces the concentration of those compounds to levels below the limit of detection by smell or by standard equipment, i.e. so that they are virtually entirely removed. Thus, the process is preferably effective at removing malodor caused by nitrogen containing compounds.

The process does not necessarily reduce the concentration of every one of the one or more undesired compound, but it may do so.

The composition to be treated by the process of the present invention can be in any suitable form. For example, it may be in the form of a solid, a slurry, a liquid or a solution.

If the composition to be treated is a solid or semi-solid it may be dissolved or dispersed in a solvent before it is brought into contact with the extraction solvent. If the composition has a “waxy” consistency, is a semi-solid or otherwise cannot be formed into a powdery solid it is advantageous for it to be dissolved or formed into a slurry prior to treatment as this provides an increased surface area for contact with the extraction solvent. Suitable solvents include water.

The extraction solvent that is used in the process of the present invention contains at least one (hydro)fluorocarbon. By the term “(hydro)fluorocarbon” we mean a compound selected from the group consisting of the hydrofluorocarbons and the perfluorocarbons. By the term “hydrofluorocarbon” we mean a compound which contains only carbon, hydrogen and fluorine atoms.

The extraction solvent should, of course, be in liquid form. Where the solvent comprises one or more low boiling compounds which are gases at room temperature, the required liquid form may be attained by cooling the solvent to a suitably low temperature or by subjecting it to super-atmospheric pressures at some point before it is contacted with the composition.

Suitable perfluorocarbons include hexafluoroethane (R-116) and octafluoropropane (R-218).

Suitable hydrofluorocarbons include the hydrofluoromethanes, the hydrofluoroethanes and the hydrofluoropropanes, such as trifluoromethane (R-23), fluoromethane (R-41), difluoromethane (R-32), pentafluoroethane (R-125), 1,1,1-trifluoroethane (R-143a), 1,1,2,2-tetrafluoroethane (R-134), 1,1,1,2-tetrafluoroethane (R-134a), 1,1-difluoroethane (R-152a), 1,1,1,3,3-pentafluoropropane (R-245fa), 1,1,2,2,3-pentafluoropropane (R-245ca), 1,1,1,2,3-pentafluoropropane (R-245eb), 1,1,2,3,3-pentafluoropropane (R-245ea), 1,1,1,2,3,3-hexafluoropropane (R-236ea), 1,1,1,2,2,3-hexafluoropropane (R-236cb), 1,1,1,3,3,3-hexafluoropropane (R-236fa), 1,1,1,2,3,3,3-heptafluoropropane (R-227ea) and 1,1,1,2,2,3,3-heptafluoropropane (R-227ca). Particularly preferred hydrofluorocarbons include R-134a, R-245fa, R-236ea and R-227ea, especially R-134a.

Solvents containing mixtures of two or more (hydro)fluorocarbons may be used if desired.

The extraction solvent that is used in the process of the present invention may also comprise a co-solvent in addition to the (hydro)fluorocarbon.

Suitable co-solvents include, inter alia, fluorine free and more particularly halogen free compounds. Suitable halogen free co-solvents will typically have a boiling point of 80° C. or below, for example in the range of from −85 to 80° C. The preferred co-solvents have a boiling point of 60° C. or below, for example in the range of from −85 to 60° C., preferably 20° C. or below, for example in the range of from −70 to 20° C., and more preferably 10° C. or below, for example in the range of from −60 to 10C. Mixtures of two or more co-solvents may be used if desired.

Suitable co-solvents may be selected from the C₂₋₆, particularly the C₂₋₄ hydrocarbon compounds by which we mean compounds containing only carbon and hydrogen atoms. Suitable hydrocarbons may be aliphatic or alicyclic. Preferred hydrocarbons are the alkanes and cycloalkanes, with alkanes such as ethane, n-propane, i-propane, n-butane and i-butane being especially preferred.

Other suitable co-solvents include the hydrocarbon ethers, by which we mean compounds having the formula R¹—O—R² in which R¹ and R² are independently hydrocarbyl groups containing only carbon and hydrogen atoms, such as C₁₋₆ and preferably C₁₋₃ alkyl groups. Preferred diallcyl ethers include dimethyl ether, methyl ethyl ether and diethyl ether.

Still further suitable co-solvents may be selected from the amides, sulphoxides, alcohols, ketones, carboxylic acids, carboxylic acid derivatives, inorganic acids and nitro compounds.

Preferred amide co-solvents include the N,N′-dialkylamides and alkylamides, especially dimethylformamide and formamide.

Preferred sulphoxide co-solvents include the dialkylsulphoxides, especially dimethylsulphoxide.

Preferred alcohol co-solvents include the aliphatic alcohols, particularly the alkanols. Preferred alkanols are selected from the C₁₋₆, particularly the C₁₋₃ alkanols, with methanol, ethanol, 1-propanol and 2-propanol being especially preferred.

Preferred ketone co-solvents include the aliphatic ketones, particularly the dialkyl ketones. A particularly preferred diallyl ketone is acetone.

Preferred carboxylic acid co-solvents include formic acid and acetic acid.

Preferred carboxylic acid derivatives for use as co-solvents include the anhydrides, especially acetic anhydride, and the C₁₋₆, particularly the C₁₋₃ alkyl esters of C₁₋₆, particularly C₁₋₃ alkanoic acids, especially ethyl acetate.

Preferred nitro compounds for use as co-solvents include the nitroalkanes and nitroaryl compounds, with nitromethane and nitrobenzene being especially preferred.

The extraction solvent typically comprises from 50.0 to 100% by weight, e.g. from 50.0 to 99.5% by weight, of a (hydro)fluorocarbon and from 0 to 50% by weight, e.g. from 0.5 to 50% by weight, of a co-solvent. Preferred extraction solvents comprise from 70.0 to 100.0% by weight, e.g. from 70.0 to 99.0% by weight, of the (hydro)fluorocarbon and from 0 to 30% by weight, e.g. from 1 to 30% by weight, of the co-solvent. Particularly preferred extraction solvents comprise from 80.0 to 100.0% by weight, e.g. from 80.0 to 99.0% by weight, of the (hydro)fluorocarbon and from 0 to 20.0% by weight, e.g. from 1.0 to 20.0% by weight, of the co-solvent.

The composition of the extraction solvent blend can be varied during the course of the extraction process to enhance the resolution of the separation.

If the co-solvent is a flammable material, which will be the case with the hydrocarbon, hydrocarbon ether and alkanol co-solvents identified above, then the extraction solvent will preferably comprise sufficient of a non-flammable (hydro)fluorocarbon to render the solvent non-flammable overall. Where the extraction solvent is a blend of one or more compounds, the resulting blend may be zeotropic, azeotropic or azeotrope-like.

As the skilled person will appreciate, the (hydro)fluorocarbon(s) and optionally co-solvent(s) can be selected depending on the nature of the undesired compound(s) to be extracted so as to enhance extraction.

The process of the present invention is particularly suitable for removing contaminants from calcium fluoride, CaF₂. Processes for synthesising CaF₂ typically provide either a wet slurry of CaF₂ containing water and any solid or liquid contaminants or a “cake” of CaF₂ where the liquid has been separated from the CaF₂ but potentially leaving it contaminated with solid or semi-solid compounds. The synthesis of other insoluble inorganic halides often produces the product in similar forms.

The process of the present invention can be used to reduce the concentration of contaminants in such insoluble inorganic halides, especially fluorides. For example it can be used to remove odoriferous compounds from CaF₂ and thus leave CaF₂ without odour or with a significantly reduced odour. Additionally, it has surprisingly been found that the process of the present invention may improve the morphology of CaF₂, making it more suitable for uses such as HF synthesis and metal-worldng.

In a preferred aspect, the present invention provides a process comprising contacting a solid composition of CaF₂ and contaminating material such as odoriferous material or a slurry of such a composition in water with a (hydro)fluorocarbon containing extractive solvent such that the contaminating material is extracted into the extractive solvent. Preferably the solvent is R-134a. If a slurry is used, it typically contains 5 to 30% w/w, for example, 5 to 10% w/w CaF₂ in water.

The process of the invention can also be used to remove undesirable materials from aqueous solutions of inorganic fluoride, such as potassium fluoride. Such solutions typically contain 20 to 40% w/w of the inorganic fluoride in water. However, the skilled person will appreciate that the amount of inorganic fluoride in solution will depend on factors such as the solubility of the fluoride and the process that was used to produce it.

In a preferred aspect, the present invention provides a process comprising contacting an aqueous solution of KF and contaminating material such as odoriferous material, which may contain up to 10% KOH with a (hydro)fluorocarbon containing extractive solvent such that the contaminating material is extracted into the extractive solvent. Preferably the solvent is R-134a.

After an aqueous solution of a soluble inorganic fluoride has been subjected to the process of the invention, it may optionally be precipitated by the addition of any suitable inorganic salt such as an inorganic hydroxide. For example a KF solution may be precipitated by the addition of a calcium salt such as quick-lime, hydrated lime or Ca(OH)₂ which gives CaF₂ and KOH, both of which can be used in other ways.

The composition to be treated may be contacted with the extraction solvent in any suitable manner that would be readily apparent to the person of ordinary skill in the art. For example, simple mixing may be used. If the composition is in the form of an aqueous solution, the extractive solvent may be contacted with the solution in a co- or counter current fashion. The extractive solvent is preferably R-134a.

The extraction solvent, after contacting the composition, may be removed by any standard method known in the art. For example, when the composition is a solid, the extraction solvent is decanted to leave the solid. If the composition is a slurry, the desired compound(s) will typically remain in an aqueous phase and the extractive solvent can be removed by phase separation techniques. If the composition is in the form of an aqueous solution, the extractive solvent can be removed by standard liquid-liquid separation techniques.

Once the extractive solvent has been removed from the composition, the contaminated solvent can be regenerated using any suitable method. For example, the contaminated solvent can be evaporated to leave a residue containing the undesired compounds. The vaporised solvent can be captured and, if appropriate, recycled to another extraction, stored or used for another purpose.

The process of the present invention is usually conducted at a temperature in the range of from −30 to 70° C. Operating temperatures at or below ambient, e.g. in the range of from 0 to 30° C., are preferred.

The process of the present invention may be conducted at atmospheric, sub-atmospheric or super-atmospheric pressures. The precise operating pressure will depend, inter alia, on the extraction solvent that is used, particularly its boiling point. Preferred operating pressures are in the range of from 0.1 to 200 bar, more preferably in the range of from 1 to 30 bar and particularly in the range of from 3 to 10 bar.

A combination of temperature and pressure is selected so that the extraction solvent is liquid under the conditions used.

The composition which is finally obtained from the process of the present invention may be used as it is or, alternatively, it may be subjected to one or more further processes, for example to purify the composition further or to isolate a given constituent or constituents contained in the composition.

It should also be appreciated that a composition to be treated may be subjected to the process of the present invention more than one time in order to reduce the content of undesired compounds still further and produce a product that is richer in the desired compounds.

In such a process, the composition may be subjected to repeated contacts with one extractive solvent or subjected to contacts with more than one type of solvent. Repeated contact will further reduce the content of the one or more undesired compounds.

Typically, the composition to be treated may be contacted with the extractive solvent as many times as necessary to improve the properties of the desired compound(s), for example remove malodor and/or so that no undesired compounds are detected using standard techniques. The number of times that a composition is contacted with the solvent depends on a number of factors, such as the initial level of the undesirable compounds.

Typically, it is not necessary to subject the composition to any additional treatment(s) prior to or after the process of the present invention in order to give the required level of purity, for example to ensure that there is no malodor.

However, if desired, the process can include one or more additional purifying steps, which may be conducted before and/or after the process of the present invention. The additional purifying steps may reduce the concentration of undesired compounds that are reduced/removed by the process of the present invention or they may remove other undesired compounds and/or improve other properties of the desired compounds such as their morphology.

The apparatus that is used to carry out the process of the present invention may employ a solvent recovery system which removes the solvent from the eluate recovered by evaporation and then condenses the resulting solvent vapour for reuse.

A suitable recovery system for low boiling point solvents, by which we mean solvents having a boiling point of 25° C. or below, e.g. 0° C. or below, comprises an evaporator into which the eluate emerging from the process is passed, a compressor for compressing the vapour generated in the evaporator and a condenser for cooling the compressed vapour emerging from the compressor. The solvent is removed from the eluate in the evaporator by flash evaporation induced by suction from the compressor and the solvent vapour so generated then passes to the compressor, which may be a diaphragm compressor, where it is compressed. From the compressor, the solvent vapour passes to the condenser where it is cooled and returned to liquid form for recharging to the process or possibly to a solvent reservoir supplying solvent to the process. The condenser, which may take the form of a coiled tube, can be arranged inside the evaporator so that the latent heat of condensation provides at least some of the energy required to evaporate the solvent, the remainder being supplied by the work done by the compressor.

A further suitable recovery system for low boiling point solvents comprises a solvent recycling circuit comprising an evaporator into which the eluate emerging from the process is passed and in which the solvent is evaporated and a condenser in which the vapour emerging from the evaporator is cooled and returned to liquid form for recharging to the process or possibly to a solvent reservoir supplying solvent to the process. Heating of the evaporator and cooling of the condenser may be carried out independently, but in a preferred embodiment an external heat pump system is used to both heat the evaporator and to cool the condenser. The external heat pump system comprises an evaporator, a compressor, a condenser and an expansion valve which are sequentially arranged in a circuit through which a heat transfer fluid is caused to flow. The evaporator of the external heat pump system, which may take the form of a coiled tube, is arranged inside or around the outside of the condenser of the solvent recycling circuit so that evaporation of the heat transfer fluid in the evaporator cools the condenser and provides for the condensation of the solvent vapour passing through the solvent recycling circuit. The vapour generated in the evaporator of the external heat pump system is then compressed and passes to the condenser where it condenses and gives off heat. The condenser of the external heat pump system, which may also take the form of a coiled tube, is arranged inside or around the outside of the evaporator of the solvent recycling circuit so that the latent heat of condensation associated with the condensation of the heat transfer fluid provides the heat required to evaporate the solvent passing through the solvent recycling circuit. The condensed heat transfer fluid is then returned through an expansion valve to the evaporator so completing the cycle in the external heat pump system.

As an alternative to an external heat pump system, an external circulating heat-transfer fluid may be used to transfer the heat of solvent condensation to the evaporator vessel to provide heat for solvent evaporation.

The process of the present invention may be operated in a batch, batch continuous or continuous fashion.

The present invention is now illustrated but not limited by the following Example.

### EXAMPLE

2 g of CaF₂ which was contaminated with residues from an alkylation process were placed in a glass aerosol bottle, about 10 ml of water was is added and the mixture shaken to produce a slurry. An aerosol fitting was then secured onto the top of the vessel to seal it. Liquid R-134a was then admitted to the vessel and the contents shaken for about 30 seconds. The reaction was performed at ambient temperature (about 22° C.) and a pressure of approximately 7 bar.

Two phases were clearly visible although clear separation of the two phases was not observed. In order to speed up the separation of the two phases the solution was placed in the freezer (about −22° C.) for 30 minutes after which it was removed to room temperature. The R-134a was immediately vented into a glass beaker whereupon contact it vaporised leaving behind an odoriferous residue. All the R-134a was removed in this way and when it was deemed that only the semi-frozen CaF₂ slurry remained this was vented into another glass beaker. This was allowed to warm to room temperature and the water allowed to evaporate.

The residual CaF₂ had faint detectable odour.

An improvement in the morphology of the CaF₂ was also seen. The contaminated CaF₂ was a beige coloured solid that was not evenly divided and was prone to “clumping” (i.e. it was a wet cake). The CaF₂ obtained after the process had lost most of its colour and could be broken into a powder.

1. A process for treating a composition comprising one or more undesired compounds and one or more desired compounds so as to reduce the concentration of at least one of the undesired compounds, the process comprises the steps of:
(1) contacting the composition with an extraction solvent comprising a (hydro)fluorocarbon, and
(2) separating the solvent from the one or more desired compounds;
wherein one or more of the desired compounds is an alkali metal fluoride or an alkaline earth metal fluoride.

2. A process according to claim 1, wherein the alkali metal fluoride or alkaline earth metal fluoride is calcium fluoride or potassium fluoride.

3. A process according to claim 1 and claim 2, wherein at least one of the undesired compounds is odoriferous.

4. A process according to claim 1, wherein at least one of the undesired compounds is a sulfur and/or nitrogen containing compound.

5. A process according to claim 4, wherein the undesired sulfur containing compound is selected from the group consisting of: carbon disulfide, carbonyl sulfide, dimethyldisulfide, ethanethiol, diethyldisulfide, 1,3-dihydro-2II-imidazole 2-thione, 2-(methylthio)-propane, 2-(methylthio)-butane, 1-(methylthio)-butane, methylethyldisulfide, 2-(ethylthio)-butane, sec-butyl isopropylsulfide, 1-(ethylthio)-butane, 1-[(methylethyl)thio]butane and bis[2-(ethylthio)ethyl]ether, and combinations thereof.

6. A process according to claim 4, wherein the undesired nitrogen containing compound is selected from the group consisting of: ammonia, nitromethane, methylamine, dimethylamine, trimethylamine, LDA (lithium diisopropylamide), hydroxylamine, ureas, ethylarnine, diethylamine, triethylarnine, 1,3-dihydro-2H-imidazole-2-thione, N,N-dimethyl-ethanethioamide and 2,2-dimethoxy-N-methyl-ethanamine, or combinations thereof.

7. A process according to claim 1, wherein the composition is in the solid state or in the form of a slurry.

8. A process according to claim 1, wherein the composition is in the liquid phase.

9. A process according to claim 1, wherein the extraction solvent comprises at least one (hydro)fluorocarbon selected from the group consisting of: (hydro)fluoromethanes, (hydro)fluoroethanes, (hydro)fluoropropanes, and combinations thereof.

10. A process according to claim 9, wherein the extraction solvent comprises at least one (hydro)fluorocarbon selected from the group consisting of: trifluoromethane (R-23), fluoromethane (R-41), difluoromethane (R-32), pentafluoroethane (R-125), 1,1,1-trifluoroethane (R-143a), 1,1,2,2-tetrafluoroethane (R-134), 1,1,1,2-tetrafluoroethane (R-134a), 1,1-difluoroethane (R-152a), 1,1,1,3,3-pentafluoropropane (R-245fa), 1,1,2,2,3-pentafluoropropane (R-245ca), 1,1,1,2,3-pentafluoropropane (R-245eb), 1,1,2,3,3-pentafluoropropane (R-245ea), 1,1,1,2,3,3-hexafluoropropane (R-236ea), 1,1,1,2,2,3-hexafluoropropane (R-236cb), 1,1,1,3,3,3-hexafluoropropane (R-236fa), 1,1,1,2,3,3,3-heptafluoropropane (R-227ea) and 1,1,1,2,2,3,3-heptafluoropropane (R-227ca), and combinations thereof.

11. A process as claimed in claim 10, wherein the extraction solvent comprises at least one compound selected from the group consisting of: 1,1,1,2-tetrafluoroethane (R-134a), 1,1,1,3,3-pentafluoropropane (R-245fa), 1,1,1,2,3,3-hexafluoropropane (R-236ea) and 1,1,1,2,3,3,3-heptafluoropropane (R-227ea), and combinations thereof.

12. A process as claimed in claim 11, wherein the extraction solvent comprises 1,1,1,2-tetrafluoroethane (R-134a).

13. A process according to claim 1, wherein the extraction solvent further comprises a co-solvent.

14. A process as claimed in claim 13, wherein the co-solvent is halogen free.

15. A process according to claim 1, wherein said process is conducted at a temperature in the range of from 0 to 30° C.

16. A process according to claim 1, wherein said process is conducted at a pressure in the range of from 1 to 30 bar.

17. process for treating a composition comprising one or more undesired compounds and one or more desired compounds so as to reduce the concentration of at least one of the undesired compounds, the process comprises the steps of:
(1) contacting the composition with an extraction solvent comprising:
a (hydro)fluorocarbon; and
a co-solvent;
(2) separating the solvent from the one or more desired compounds;
wherein one or more of the desired compounds is an alkali metal fluoride or an alkaline earth metal fluoride; and
wherein at least one of the undesired is a sulfur and/or nitrogen containing compound.

18. he process according to claim 17 wherein said co-solvent is halogen free.

19. A process for treating a composition comprising one or more undesired compounds and one or more desired compounds so as to reduce the concentration of at least one of the undesired compounds, the process comprises the steps of:
(1) contacting the composition with an extraction solvent comprising a extraction solvent comprises at least one (hydro)fluorocarbon selected from the group consisting of: (hydro)fluoromethanes, (hydro)fluoroethanes, (hydro)fluoropropanes, and combinations thereof;
(2) separating the solvent from the one or more desired compounds;
wherein one or more of the desired compounds is an alkali metal fluoride or an alkaline earth metal fluoride; and
wherein at least one of the undesired is a sulfur and/or nitrogen containing compound.
